(19) United States
(12) Patent Application Publication
(10) Pub. No.: US 2014/0149595 A1
(43) Pub. Date: May 29, 2014

(54) METHOD OF COMMUNICATING IN PATH COMPUTATION ELEMENT COMMUNICATION PROTOCOL AND NETWORK APPARATUS

(71) Applicant: Huawei Technologies Co., Ltd., Shenzhen (CN)

(72) Inventors: Dhruv DHODY, Bangalore (IN); Udayasree PALLE, Bangalore (IN)

(73) Assignee: Huawei Technologies Co., Ltd., Shenzhen (CN)

(21) Appl. No.: 14/167,684

(22) Filed: Jan. 29, 2014

Related U.S. Application Data
(63) Continuation of application No. PCT/CN2012/078583, filed on Jul. 13, 2012.

(30) Foreign Application Priority Data
Aug. 16, 2011 (IN) IN2325/DEL/2011

(51) Int. Cl. H04L 12/701

(52) U.S. Cl. CPC H04L 45/00
USPC 709/230

(57) ABSTRACT

The embodiments of the present invention provide a method of communicating in PCEP and a network apparatus for communicating in PCEP. The method comprising: receiving a Path Computation Request message; wherein the Path Computation Request message includes a Data Structure object, and the Data Structure object is used to specify the data structure of computed paths; sending a Path Computation Reply message; wherein the Path Computation Reply message includes the computed paths, and the computed paths are based on the Data Structure object. Through the embodiments of the present invention, PCEP should be extended to allow flexibility in use of different data structure based on the use-case and objective function.

### CROSS-REFERENCE TO RELATED APPLICATIONS

This application is a continuation of International Patent Application No. PCT/CN2012/078583, filed on Jul. 13, 2012, which claims priority to India Patent Application No. IN2325/DEL/2011, filed on Aug. 16, 2011, both of which are hereby incorporated by reference in their entireties.

### FIELD OF THE INVENTION

This application relates to Traffic Engineering (TE) and in particular, to a method of communicating in Path Computation Element Communication Protocol (PCEP) and a network apparatus.

### BACKGROUND

In TE networks, such as Multiprotocol Label Switching (MPLS) networks and Generalized MPLS networks, a Label Switched Path (LSP) can be established with a path provided by a Path Computation Client (PCC) and Path Computation Element (PCE).

Specifically, the PCC requests a path or route from the PCE, which computes the path and forwards the computed path information back to the PCC. PCEP is such a protocol designed specifically for communications between a PCC and PCE, or between two PCEs.

A PCC may use PCEP to send a path computation request (such as PCReq message) to a PCE, and the PCE may reply a message (such as PCRep message) with a set of computed paths if one or more paths can be found that satisfies the set of constraints. On the other hand, Virtual Shortest Path Tree (VSPT) is defined as a default data structure for PCRep messages in inter-domain scenarios.

However, the applicant found that VSPT is the only way PCE will reply and form PCRep messages in inter-domain scenarios, and PCEP could not be generic enough to support multiple data structure and objective functions.
[symbol] Reference 1 [symbol] “Path Computation Element (PCE) Communication Protocol (PCEP)”, RFC 5440. Reference 1 is incorporated by reference.
[symbol] Reference 2 [symbol] “A Backward-Recursive PCE-Based Computation (BRPC) Procedure to Compute Shortest Constrained Inter-Domain Traffic Engineering Label Awitched Paths”, RFC 5441. Reference 2 is incorporated by reference.
[symbol] Reference 3 [symbol] “Encoding of Objective Function in the Path Computation Element Communication Protocol (PCEP)”, RFC 5541. Reference 3 is incorporated by reference.

### SUMMARY

Embodiments of the present invention pertain to a method of communicating in PCEP and network apparatus. The aim is to extend the PCEP to allow flexibility in use of different data structures based on the use-case and objective function.

According a first aspect of the embodiments of the present invention, there is provided a method of communicating in PCEP, the method including:

receiving a Path Computation Request message; wherein the Path Computation Request message includes a Data Structure object, and the Data Structure object is used to specify the data structure of computed paths;

sending a Path Computation Reply message; wherein the Path Computation Reply message includes the computed paths, and the computed paths are based on the Data Structure object.

According a second aspect of the embodiments of the present invention, there is provided a method of communicating in PCEP, the method including:

sending a Path Computation Request message; wherein the Path Computation Request message includes a Data Structure object, and the Data Structure object is used to specify the data structure of computed paths;

receiving a Path Computation Reply message; wherein the Path Computation Reply message including the computed paths, and the computed paths are based on the Data Structure object.

According a third aspect of the embodiments of the present invention, there is provided a network apparatus, the network apparatus including:

a first receiver, configured to receive a Path Computation Request message; wherein the Path Computation Request message includes a Data Structure object, and the Data Structure object is used to specify the data structure of computed paths;

a first sender, configured to send a Path Computation Reply message; wherein the Path Computation Reply message includes the computed paths, and the computed paths are based on the Data Structure object.

According a fourth aspect of the embodiments of the present invention, there is provided a network apparatus, the network apparatus including:

a second sender, configured to send a Path Computation Request message; wherein the Path Computation Request message includes a Data Structure object, and the Data Structure object is used to specify the data structure of computed paths;

a second receiver, configured to receive a Path Computation Reply message; wherein the Path Computation Reply message includes the computed paths, and the computed paths are based on the Data Structure object.

According a fifth aspect of the embodiments of the present invention, there is provided a computer-readable program, wherein when the program is executed in a network apparatus, the program enables the computer to carry out the method of communicating in PCEP.

According a sixth aspect of the embodiments of the present invention, there is provided a storage medium in which a computer-readable program is stored, wherein the computer-readable program enables the computer to carry out the method of communicating in PCEP.

The advantages of the present invention exist in that PCEP should be extended to allow flexibility in use of different data structure based on the use-case and objective function.

These and further aspects and features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWING

The drawings are included to provide further understanding of the present invention, which constitute a part of the specification and illustrate the preferred embodiments of the present invention, and are used for setting forth the principles of the present invention together with the description. The same element is represented with the same reference number throughout the drawings.

In the drawings:

FIG. 1 is a topology diagram showing a HOP-LIMIT in one scenario.

FIG. 2 is a schematic diagram of forming VSPT in the topology of FIG. 1.

FIG. 3 is a topology diagram showing P2MP in another scenario.

FIG. 4 is a schematic diagram of forming VSPT in the topology of FIG. 3.

FIG. 5 is a topology diagram showing the core tree according to the VSPT formed as shown in FIG. 4.

FIG. 6 is a topology diagram showing an optimal tree.

FIG. 7 is flowchart of the method of an embodiment of the present invention.

FIG. 8 is flowchart of the method of another embodiment of the present invention.

FIG. 9 is a schematic diagram of the network apparatus of an embodiment of the present invention.

FIG. 10 is a schematic diagram of the network apparatus of another embodiment of the present invention.

### DETAILED DESCRIPTION

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

In the present application, embodiments of the invention are described primarily in the context of a PCC or PCE. However, it shall be appreciated that the invention is not limited to the context of a PCC or PCE, and may relate to any type of appropriate electronic apparatus having the function of PCC or PCE.

The preferred embodiments of the present invention are described as follows in reference to the drawings.

The Backward Recursive PCE-based Computation (BRPC) procedure is a multiple-PCE path computation technique as described in [reference 2]. The BRPC procedure relies on communication between cooperating PCEs. In particular, the PCC sends a PCReq message to a PCE in its domain. The request is forwarded between PCEs, domain-by-domain, until the PCE responsible for the domain containing the LSP destination is reached.

The PCE in the destination domain creates a tree (VSPT) of potential paths to the destination, and passes this back to the previous PCE in a PCRep message. Each PCE in turn adds to the VSPT and passes it back until the PCE in the source domain uses the VSPT to select an end-to-end path that the PCE sends to the PCC. However, there are some problems using VSPT as the only data structure in PCEP.

For example, in scenarios of Point to Multiple Point (P2MP), Pruning by intermediate PCE will not be able to give the complete result, so basic VSPT will not work in P2MP case.

Furthermore, in case of multiple entry nodes to the leaf domain, multiple VSPT for each entry node must be carried. Each link in the VSPT is a full path, and a lot of data may be duplicated. The response time is longer because of the above reason.

And in case of VSPT, the metric data available is end-to-end. Applying the Objective Function (minimum cost tree) is not possible. There are chances for constraint like HOP-LIMIT to fail, i.e. even though a path meeting HOP-LIMIT exists, the VSPT algorithm will not be able to find it.

There is another example in scenarios of Point to Point (P2P) or Hierarchy PCE (HPCE). Since each link in VSPT is an end to end path, there is duplication of data. In situations with many entry nodes, the same data may be repeated for each link. There are chances for constraints like HOP-LIMIT to fail, i.e. even though a path meeting HOP-LIMIT exists, the VSPT algorithm will not be able to find it. Furthermore, VSPT in HPCE architecture makes little sense.

FIG. 1 is a topology diagram showing HOP-LIMIT exists in one scenario. As shown in FIG. 1, there are Domain 10 and Domain 20, and a shortest path from A to K with HOP-LIMIT of 5 needs to be found.

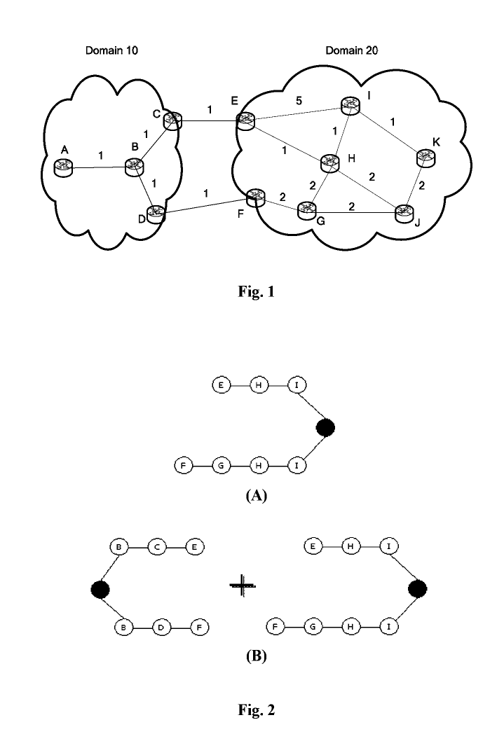

FIG. 2 is a schematic diagram of forming VSPT in topology as shown in FIG. 1. As shown in FIG. 2, the PCE of Domain 20 will form and return the VSPT, and this VSPT is received and combined at the PCE of Domain 10.

However, the PCE of Domain 10 does not find any path that meets the HOP-LIMIT constraints. A-B-C-E-I-K exists which meets HOP-LIMIT constraints, but VSPT data structure cannot handle it.

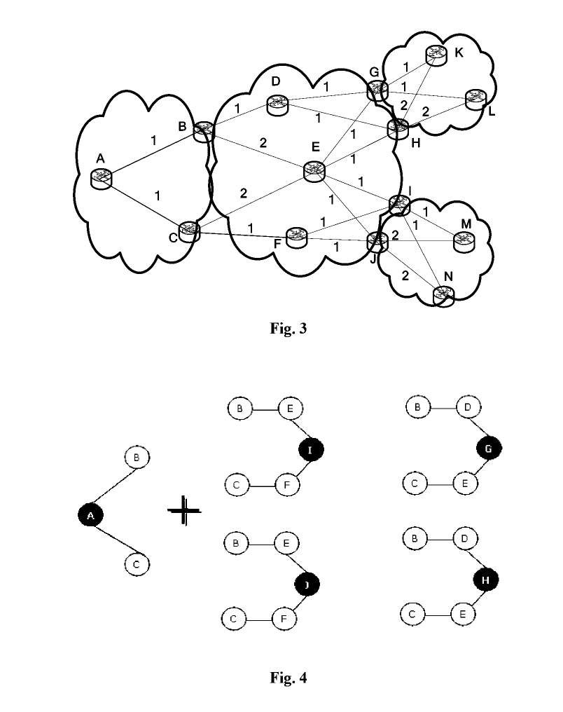

FIG. 3 is a topology diagram showing in P2MP in another scenario. As shown in FIG. 3, A is the ingress and K, L, M and N are the egress of the P2MP inter-domain TE LSP.

FIG. 4 is a schematic diagram of forming VSPT in topology as shown in FIG. 3. As shown in FIG. 4, the VSPT returned to the PCE of the source domain would be formed.

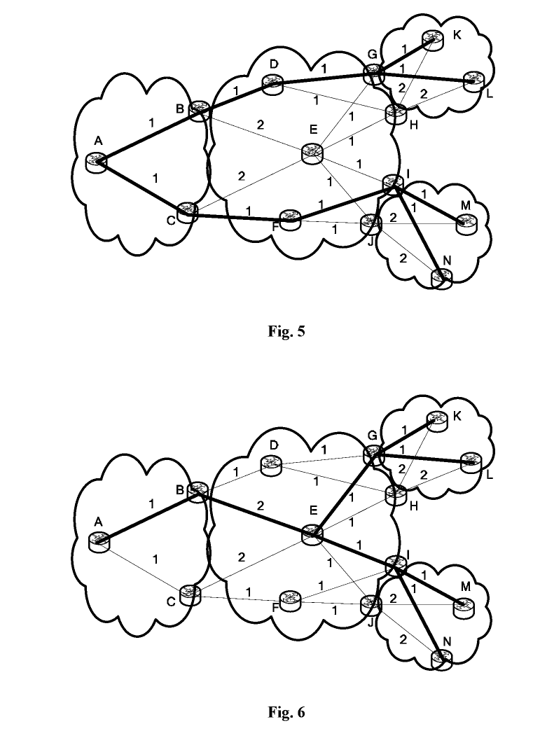

FIG. 5 is a topology diagram showing the core tree according to the VSPT formed as shown in FIG. 4. As shown in FIG. 5, this is not an optimal tree because of the total cost of this tree is 10.

FIG. 6 is a topology diagram showing an optimal tree. As shown in FIG. 6, the correct optimal tree would be with cost 9 if extended VSPT is used and all paths are propagated.

So, extended VSPT in which all paths are maintained is needed. PCEP should be extended to let PCE advertise supported data structure, and to let PCC/PCE to request/reply a data structure during path computation, and appropriate error handling.

The embodiments of the present invention provide a method of communicating in PCEP, and the method applied for a PCE.

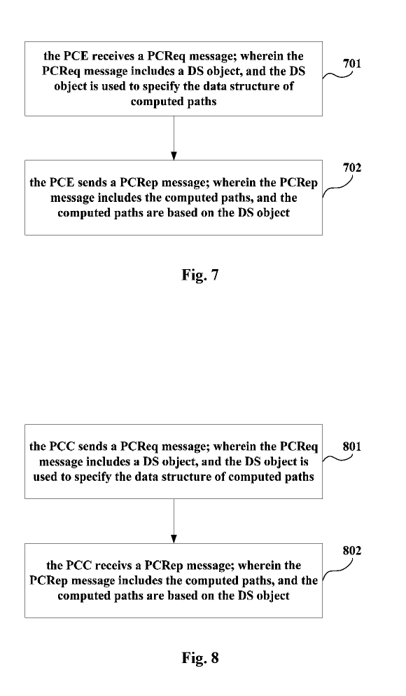

FIG. 7 is flowchart of the method of an embodiment of the present invention. As shown in FIG. 7, the method including:

Step 701, the PCE receives a PCReq message; wherein the PCReq message includes a Data Structure (DS) object, the DS object is used to specify the data structure of computed paths;

Step 702, the PCE sends a PCRep message; wherein the PCRep message includes the computed paths, the computed paths are based on the DS object.

In the present application, the PCE may receive the PCReq message from a PCC, or from another PCE. And the PCE may send the PCRep message to a PCC, or to another PCE.

In an embodiment of the present invention, the PCReq message included the DS object looks like:

<PCReq Message> ::= <Common Header>

[<svec-list>]
<request-list>

where:

<svec-list> ::= <SVEC>

[<OF>]
[<DS>]
[<metiric-list>]
[<svec-list>]

<request-list> ::= <request> [<request-list>]
<request> ::= <RP>

<END-POINTS>
[<LSPA>]
[<BANDWIDTH>]
[<metric-list>]
[<OF>]
[<DS>]
[<RRO>[<BANDWIDTH>]]
[<IRO>]
[<LOAD-BALANCING>]

and where:

<metric-list> ::= <METRIC>[<metric-list>]

Wherein, DS could be specified separately for each request in case synchronization or for all together. The format of the PCReq message is updated as aboved information, but it is not limited thereto.

In another embodiment of the present invention, P bit can be used to specify if mandatory. The P bit is specified in [reference 1], and may be set by a PCC to mandate that a PCE must take the information carried in the DS object into account during the path computation.

The new PCEP object (DS object) is defined, and it is carried within PCReq message in order for the PCC to indicate the data structure of computed paths. The format of the DS object is:

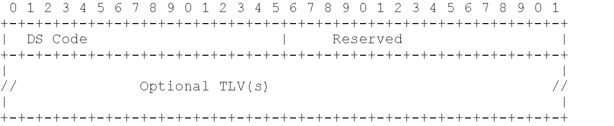

In the present application, the DS object format may be compliant with the PCEP object format defined in [reference 1]. The DS object includes a Data Structure Code (DS Code), the DS Code is the identifier of the DS object. The DS Code field may be 2 bytes.

In the present application, the Reserved field of the DS object may be 2 bytes, and this field must be set to zero on transmission and be ignored on receipt. The Optional TLVs of the DS object may be defined so as to encode data structure parameters.

In an embodiment of the present invention, the value of the DS Code is 1, which indicates the DS object is a VSPT. Or, the value of the DS Code is 2, which indicates the DS object is a VSPT without pruning. Or, the value of the DS Code is 3, which indicates the DS object is a PathList.

For example, the PathList (i) is defined:

$$PathList ( i ) = \{ \begin{matrix}For i = n \text{:} all possible paths meeting the constraints \\ between NB - en ( k , n ) to destination \\ For 1 < i < n \text{:} [ \begin{matrix}all possible paths meeting the \\ constraints between BN - en ( k , i ) to BN - ex ( l , i )\end{matrix} ] + \\ PathList ( i + 1 ) \\ For i = 1 \text{:} [ \begin{matrix}all possible paths meeting the constraints between \\ Source to BN - ex ( 1 , 1 )\end{matrix} ] + PathList ( 2 )\end{matrix}$$

Wherein, the BN-en( ) and BN-ex( ) are as described in [reference 2], and please refer to the prior art, which shall not be described any further.

In the present application, during PCEP session setup phase, the PCE can advertise supported data structure. So a new PCEP TLV (Data Structure List, DS-List) is defined and carried within an OPEN object.

In an embodiment of the present invention, before receiving the PCReq message, the method further includes: the PCE sends an Open message, wherein the Open message includes an OPEN object;

wherein the OPEN object is carried a DS-List TLV, the DS-List TLV indicates the list of supported data structure.

Furthermore, the DS-List TLV has the following format:

TYPE: 4

LENGTH: N*2, wherein N is the number of supported data structure.

VALUE: a list of DS Code points identifying the supported data structure. It looks like:

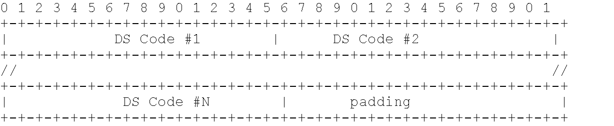

In the present application, the DS-List TLV format is compliant with the PCEP TLV format defined in [reference 1]. That is the TLV is composed of 2 octets for the type, 2 octets specifying the TLV length, and a value field. And please refer to the prior art, which shall not be described any further.

The embodiments of the present invention further provide a method of communicating in PCEP, the method applied for a PCC or a PCE. A PCC will be illustrated as an example in this scenario, but it is not limited thereto, it may also be a PCE.

FIG. 8 is flowchart of the method of another embodiment of the present invention. As shown in FIG. 8, the method including:

Step 801, the PCC sends a PCReq message; wherein the PCReq message includes a DS object, the DS object is used to specify the data structure of computed paths;

Step 802, the PCC receives a PCRep message; wherein the PCRep message includes the computed paths, the computed paths are based on the DS object.

In the present application, the PCC may send the PCReq message to a PCE, and the PCC may receive the PCRep message from the PCE.

In an embodiment of the present invention, the DS object includes a DS Code, the DS Code is the identifier of the DS object.

In an embodiment of the present invention, the value of the DS Code is 1, which indicates the DS object is a VSPT. Or, the value of the DS Code is 2, which indicates the DS object is a VSPT without pruning. Or, the value of the DS Code is 3, which indicates the DS object is a PathList.

In an embodiment of the present invention, before sending the PCReq message, the method further includes: the PCC receives an Open message, wherein the Open message includes an OPEN object;

wherein the OPEN object is carried a DS-List TLV, the DS-List TLV indicates the list of supported data structure.

Wherein, the value filed of the TLV is a list of DS Code points identifying the supported data structure.

It can be seen from the above embodiments that PCEP should be extended to allow flexibility in use of different data structure based on the use-case and objective function.

The embodiments of the present invention further provide a network apparatus. In the present application, the network apparatus may be a PCE.

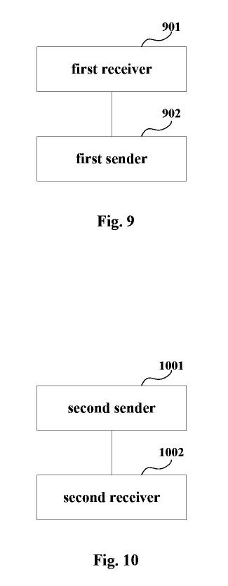

FIG. 9 is a schematic diagram of the network apparatus of an embodiment of the present invention. As shown in FIG. 9, the network apparatus includes: a first receiver 901 and a first sender 902; wherein,

the first receiver 901 is used to receive a PCReq message; wherein the PCReq message includes a DS object, the DS object is used to specify the data structure of computed paths;

the first sender 902 is used to send a PCRep message; wherein the PCRep message includes the computed paths, the computed paths are based on the DS object.

In an embodiment of the present invention, the DS object includes a DS Code, the DS Code is the identifier of the DS object.

Furthermore, the value of the DS Code is 1, which indicates the DS object is a VSPT. Or, the value of the DS Code is 2, which indicates the DS object is a VSPT without pruning. Or, the value of the DS Code is 3, which indicates the DS object is a PathList.

In an embodiment of the present invention, the first sender 902 is further used to send an Open message before the first receiver 901 has received the PCReq message, wherein the Open message includes an OPEN object;

wherein the OPEN object is carried a DS-List TLV, the DS-List TLV indicates the list of supported data structure.

Wherein, the value filed of the TLV is a list of DS Code points identifying the supported data structure.

The embodiments of the present invention further provide a network apparatus. In the present application, the network apparatus may be a PCC or a PCE.

FIG. 10 is a schematic diagram of the network apparatus of another embodiment of the present invention. As shown in FIG. 10, the network apparatus includes: a second sender 1001 and a second receiver 1002; wherein,

the second sender 1001 is used to send a PCReq message; wherein the PCReq message includes a DS object, the DS object is used to specify the data structure of computed paths;

the second receiver 1002 is used to receive a PCRep message; wherein the PCRep message includes the computed paths, the computed paths are based on the DS object.

In an embodiment of the present invention, the DS object includes a DS Code, the DS Code is the identifier of the DS object.

Furthermore, the value of the DS Code is 1, which indicates the DS object is a VSPT. Or, the value of the DS Code is 2, which indicates the DS object is a VSPT without pruning. Or, the value of the DS Code is 3, which indicates the DS object is a PathList.

In an embodiment of the present invention, the second receiver 1002 is further used to receive an Open message before the second sender 1001 sends the PCReq message, wherein the Open message includes an OPEN object;

wherein the OPEN object is carried a DS-List TLV, the DS-List TLV indicates the list of supported data structure.

wherein the value filed of the TLV is a list of DS Code points identifying the supported data structure.

It can be seen from the above embodiments that PCEP should be extended to allow flexibility in use of different data structure based on the use-case and objective function.

The embodiments of the present invention further provide a computer-readable program, wherein when the program is executed in a network apparatus; the program enables the computer to carry out the method of communicating in PCEP.

The embodiments of the present invention further provide a storage medium in which a computer-readable program is stored, wherein the computer-readable program enables the computer to carry out the method of communicating in PCEP.

It should be understood that each of the parts of the present invention may be implemented by hardware, software, firmware, or a combination thereof. In the above embodiments, multiple steps or methods may be realized by software or firmware that is stored in the memory and executed by an appropriate instruction executing system. For example, if it is realized by hardware, it may be realized by any one of the following technologies known in the art or a combination thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

The description or blocks in the flowcharts or of any process or method in other manners may be understood as being indicative of comprising one or more modules, segments or parts for realizing the codes of executable instructions of the steps in specific logic functions or processes, and that the scope of the preferred embodiments of the present invention comprise other implementations, wherein the functions may be executed in manners different from those shown or discussed, including executing the functions according to the related functions in a substantially simultaneous manner or in a reverse order, which should be understood by those skilled in the art to which the present invention pertains.

The logic and/or steps shown in the flowcharts or described in other manners here may be, for example, understood as a sequencing list of executable instructions for realizing logic functions, which may be implemented in any computer readable medium, for use by an instruction executing system, device or apparatus (such as a system including a computer, a system including a processor, or other systems capable of extracting instructions from an instruction executing system, device or apparatus and executing the instructions), or for use in combination with the instruction executing system, device or apparatus.

The above literal description and drawings show various features of the present invention. It should be understood that those skilled in the art may prepare appropriate computer codes to carry out each of the steps and processes as described above and shown in the drawings. It should be also understood that all the terminals, computers, servers, and networks may be any type, and the computer codes may be prepared according to the disclosure to carry out the present invention by using the apparatus.

Particular embodiments of the present invention have been disclosed herein. Those skilled in the art will readily recognize that the present invention is applicable in other environments. In practice, there exist many embodiments and implementations. The appended claims are by no means intended to limit the scope of the present invention to the above particular embodiments. Furthermore, any reference to “a device to . . . ” is an explanation of device plus function for describing elements and claims, and it is not desired that any element using no reference to “a device to . . . ” is understood as an element of device plus function, even though the wording of “device” is included in that claim.

Although a particular preferred embodiment or embodiments have been shown and the present invention has been described, it is obvious that equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present invention with respect to structure. Furthermore, although the a particular feature of the present invention is described with respect to only one or more of the illustrated embodiments, such a feature may be combined with one or more other features of other embodiments as desired and in consideration of advantageous aspects of any given or particular application.

What is claimed is:

1. A method of communicating in the Path Computation Element Communication Protocol (PCEP), the method comprising:
receiving a Path Computation Request message; wherein the Path Computation Request message includes a Data Structure object, and the Data Structure object is used to specify a data structure of computed paths;
sending a Path Computation Reply message; wherein the Path Computation Reply message includes the computed paths, and the computed paths are based on the Data Structure object.

2. The method according to claim 1, wherein the Data Structure object includes a Data Structure Code, and the Data Structure Code is an identifier of the Data Structure object.

3. The method according to claim 2, wherein a value of the Data Structure Code is 1, which indicates the Data Structure object is a Virtual Shortest Path Tree.

4. The method according to claim 2, wherein a value of the Data Structure Code is 2, which indicates the Data Structure object is a Virtual Shortest Path Tree without pruning.

5. The method according to claim 2, wherein a value of the Data Structure Code is 3, which indicates the Data Structure object is a PathList.

6. The method according to claim 1, wherein before receiving the Path Computation Request message, the method further comprising:
sending an Open message, wherein the Open message includes an OPEN object;
wherein the OPEN object is carried in a Data Structure List (DS-List) Type Length Value (TLV), and the DS-List TLV indicates a list of supported data structure.

7. The method according to claim 6, wherein a value field of the DS-List TLV comprises a list of Data Structure Code points identifying the supported data structure.

8. A method of communicating in the Path Computation Element Communication Protocol (PCEP), the method comprising:
sending a Path Computation Request message; wherein the Path Computation Request message includes a Data Structure object, and the Data Structure object is used to specify a data structure of computed paths;
receiving a Path Computation Reply message; wherein the Path Computation Reply message includes the computed paths, and the computed paths are based on the Data Structure object.

9. The method according to claim 8, wherein the Data Structure object includes a Data Structure Code, and the Data Structure Code is an identifier of the Data Structure object.

10. The method according to claim 9, wherein a value of the Data Structure Code is 1, which indicates the Data Structure object is a Virtual Shortest Path Tree.

11. The method according to claim 9, wherein a value of the Data Structure Code is 2, which indicates the Data Structure object is a Virtual Shortest Path Tree without pruning.

12. The method according to claim 9, wherein a value of the Data Structure Code is 3, which indicates the Data Structure object is a PathList.

13. The method according to claim 8, wherein before sending the Path Computation Request message, the method further comprising:
receiving an Open message, wherein the Open message includes an OPEN object;
wherein the OPEN Object is carried in a Data Structure List (DS-List) Type Length Value (TLV), and the DS-List TLV indicates a list of supported data structure.

14. The method according to claim 13, wherein a value field of the DS-List TLV comprises a list of Data Structure Code points identifying the supported data structure.

15. A network apparatus, the network apparatus comprising:
a first receiver, configured to receive a Path Computation Request message; wherein the Path Computation Request message includes a Data Structure object, and the Data Structure object is used to specify a data structure of computed paths;
a first sender, configured to send a Path Computation Reply message; wherein the Path Computation Reply message includes the computed paths, and the computed paths are based on the Data Structure object.

16. The network apparatus according to claim 15, wherein the Data Structure object includes a Data Structure Code, and the Data Structure Code is an identifier of the Data Structure object.

17. The network apparatus according to claim 16, wherein a value of the Data Structure Code is 1, which indicates the Data Structure object is a Virtual Shortest Path Tree.

18. The network apparatus according to claim 16, wherein a value of the Data Structure Code is 2, which indicates the Data Structure object is a Virtual Shortest Path Tree without pruning.

19. The network apparatus according to claim 16, wherein a value of the Data Structure Code is 3, which indicates the Data Structure object is a PathList.

20. The network apparatus according to claim 15, wherein the first sender is further configured to send an Open message before the first receiver has received the Path Computation Request message, wherein the Open message includes an OPEN object;
wherein the OPEN object is carried in a Data Structure List (DS-List) Type Length Value (TLV), and the DS-List TLV indicates a list of supported data structure.

21. The network apparatus according to claim 20, wherein a value field of the DS-List TLV is a list of Data Structure Code points identifying the supported data structure.

22. A network apparatus, the network apparatus comprising:
a second sender, configured to send a Path Computation Request message; wherein the Path Computation Request message includes a Data Structure object, and the Data Structure object is used to specify a data structure of computed paths;
a second receiver, configured to receive a Path Computation Reply message; wherein the Path Computation Reply message includes the computed paths, and the computed paths are based on the Data Structure object.

23. The network apparatus according to claim 22, wherein the Data Structure object includes a Data Structure Code, and the Data Structure Code is an identifier of the Data Structure object.

24. The network apparatus according to claim 23, wherein a value of the Data Structure Code is 1, which indicates the Data Structure object is a Virtual Shortest Path Tree.

25. The network apparatus according to claim 23, wherein a value of the Data Structure Code is 2, which indicates the Data Structure object is a Virtual Shortest Path Tree without pruning.

26. The network apparatus according to claim 23, wherein a value of the Data Structure Code is 3, which indicates the Data Structure object is a PathList.

27. The network apparatus according to claim 22, wherein the second receiver is further configured to receive an Open message before the second sender sends the Path Computation Request message, wherein the Open message includes an OPEN object;
wherein the OPEN object is carried in a Data Structure List (DS-List) Type Length Value (TLV), and the DS-List TLV indicates a list of supported data structure.

28. The network apparatus according to claim 27, wherein a value field of the DS-List TLV is a list of Data Structure Code points identifying the supported data structure.
